(19) United States
(12) Patent Application Publication
(10) Pub. No.: US 2026/0092902 A1
(43) Pub. Date: Apr. 2, 2026

(54) SYSTEMS AND METHODS TO DETERMINE A TEMPERATURE COMPENSATED SPEED OF SOUND FOR GASES

(71) Applicant: Honeywell International Inc., Charlotte, NC (US)

(72) Inventors: Christian Lampe-Juergens, Lotte (DE); Juri Singer, Lotte (DE); Markus Boelter, Lingen (DE); Michael Habermann, Lotte (DE)

(21) Appl. No.: 18/903,725

(22) Filed: Oct. 1, 2024

(51) Int. Cl. G01N 29/32; G01F 1/667; G01K 13/024; G01N 29/024; G01N 29/44; G01N 29/50

(52) U.S. Cl. CPC G01N 29/326; G01F 1/668; G01K 13/024; G01N 29/024; G01N 29/4472; G01N 29/50; G01N 2291/011; G01N 2291/02836; G01N 2291/02881

(57) ABSTRACT

A system and a method to determine a compensated speed of sound (SoS) for a gas is disclosed. The system comprises a first sensor configured to determine a current temperature of the gas flowing within a gas channel; a second sensor configured to emit signals within the gas to determine a gas flow rate; and at least one processor configured to determine an absolute time of flight (aToF) of the signals in an upstream direction and a downstream direction; a delta time of flight (dToF) of the signals based on the aToF in the upstream direction and downstream direction; a gas flow rate based on the aToF and the dToF; a SoS within the gas based on the aToF; and the compensated SoS for the gas based at least on the determined SoS, a base condition, the determined gas flow rate, and the determined current temperature of the gas.

### TECHNOLOGICAL FIELD

Example embodiments of the present disclosure generally relates to gas measurement and monitoring, and more particularly relates to a system and a method to determine a temperature compensated speed of sound (SoS) for gases.

### BACKGROUND

Conventionally, gas composition within distribution grids was relatively stable, predominantly consisting of natural gas injected at a few centralized points. The centralized points were monitored using gas chromatographs, ensuring a consistent and reliable measure of gas quality. However, recent changes in infrastructure and energy sources have introduced a variety of gases into the distribution grid, including liquefied natural gas (LNG), biogas, and hydrogen. The variety of gases are injected at multiple independent points throughout the distribution grid, leading to significant fluctuations in the gas composition depending on location and time. Such variability poses challenges for gas companies in maintaining consistent gas quality for end-users. Further, the different compositions can affect the calorific value and other properties of the gas, leading to potential discrepancies in billing and efficiency for consumers. Gas companies often rely on ultrasonic gas meters that measure the speed of sound to infer the gas quality. However, the measurements are heavily influenced by temperature, and thus results in complicating direct comparisons of data from different locations.

The inventors have identified numerous areas for improvement in the existing technologies and processes, which are the subjects of embodiments described herein. Through applied effort, ingenuity, and innovation, many of these deficiencies, challenges, and problems have been solved by developing solutions that are included in embodiments of the present disclosure, some examples of which are described in detail herein.

### BRIEF SUMMARY

The following presents a simplified summary in order to provide a basic understanding of some aspects of the present disclosure. This summary is not an extensive overview and is intended to neither identify key or critical elements nor delineate the scope of such elements. Its purpose is to present some concepts of the described features in a simplified form as a prelude to the more detailed description that is presented later.

In an example embodiment, a system is disclosed. The system comprises a first sensor to determine a current temperature of a gas flowing within a gas channel. The system further comprises a second sensor comprising at least two transducers. The at least two transducers are positioned and configured to emit one or more signals within the gas to determine a gas flow rate. The system further comprises at least one processor communicatively coupled to the first sensor and the second sensor. The at least one processor is configured to determine an absolute time of flight (aToF) of the one or more signals propagating through the gas between the at least two transducers in an upstream direction and a downstream direction. Further, the at least one processor is configured to determine a delta time of flight (dToF) of the one or more signals based at least on the determined aToF in the upstream direction and the downstream direction. The dToF corresponds to a difference between the aToF in the upstream direction and the aToF in the downstream direction. Further, the at least one processor is configured to determine a gas flow rate based on the aToF and the dToF. Further, the at least one processor is configured to determine a speed of sound (SoS) within the gas based at least on the aToF determined and a distance between the at least two transducers of the second sensor. Thereafter, the at least one processor is configured to determine a compensated SoS for the gas based at least on the determined SoS, a base condition, the determined gas flow rate, and the determined current temperature of the gas.

In some embodiments, the compensated SoS corresponds to a temperature compensated SoS or a temperature and flow rate compensated SoS.

In some embodiments, the at least one processor is configured to determine the temperature and optional flow rate compensated SoS based on a linear transformation model and the temperature and optional flow rate compensated SoS based on a non-linear transformation model.

In some embodiments, the at least one processor is configured to determine the temperature compensated SoS based on a non-linear transformation model and the flow rate and temperature compensated SoS based on a linear transformation model.

In some embodiments, the first sensor is positioned within the gas channel and comprises a temperature sensor and the second sensor is positioned within the gas channel and comprises a flow rate sensor.

In some embodiments, the flow rate sensor comprises an ultrasonic sensor and the one or more signals comprise one or more ultrasonic signals.

In some embodiments, the linear transformation model comprises at least two linear equations based at least on the determined SoS and the current temperature of the gas. The at least two linear equations of the linear transformation model comprise an equation for determining a compensated SoS of air and another equation for the compensated SoS of the gas.

In some embodiments, the non-linear transformation model comprises one or more non-linear equations based at least on an absolute time of flight (aToF), the current gas temperature, and the determined gas flow rate.

In some embodiments, the base condition comprises a predefined temperature of the gas or a predefined flow rate and temperature of the gas.

In some embodiments, the compensated SoS for the gas based at least on the determined SoS, a base condition, the determined gas flow rate, and the determined current temperature of the gas is determined in a head end system.

In another example embodiment, a method is disclosed. The method comprises steps of determining, via a first sensor, a current temperature of a gas flowing within a gas channel. The method further comprises determining, via a second sensor comprising at least two transducers, a gas flow rate based on one or more signals emitted by the at least two transducers within the gas. Further, the method comprises determining, via at least one processor communicatively coupled to the first sensor and the second sensor, an absolute time of flight (aToF) of the one or more signals propagating through the gas between the at least two transducers in an upstream direction and a downstream direction. Further, the method comprises determining, via the at least one processor communicatively coupled to the first sensor and the second sensor, a delta time of flight (dToF) of the one or more signals based at least on the determined aToF in the upstream direction and the downstream direction. The dToF corresponds to a difference between the aToF in the upstream direction and the aToF in the downstream direction. The method further comprises determining, via the at least one processor, a gas flow rate based on the aToF and the dToF. The method further comprises determining, via the at least one processor, a speed of sound (SoS) within the gas, based at least on the aToF determined and distance between the at least two transducers of the second sensor. Thereafter, the method comprises determining, via the at least one processor, a compensated SoS for the gas, based at least on the determined SoS, a base condition, the determined gas flow rate, and the determined current temperature of the gas.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates a block diagram of a system for determining a compensated speed of sound (SoS) for a gas, in accordance with an example embodiment of the present disclosure;

FIG. 2 illustrates flow of different gases within a distribution grid in accordance with an example embodiment of the present disclosure;

FIG. 3A illustrates a graph showing relation between the SoS and a current temperature of the gas in accordance with an example embodiment of the present disclosure;

FIG. 3B illustrates a table showing the SoS related to the gas in accordance with an example embodiment of the present disclosure;

FIG. 4 illustrates a graph showing relation between the SoS and the current temperature of the gas in linear temperature conversion in accordance with an example embodiment of the present disclosure;

FIG. 5 illustrates a graph showing relation between mean of an absolute time of flight (aToF) and mean of a gas flow rate in non-linear conversion in accordance with an example embodiment of the present disclosure; and

FIG. 6 illustrates a flowchart showing a method to determine the compensated SoS for the gas in accordance with an example embodiment of the present disclosure.

### DETAILED DESCRIPTION

Some embodiments will now be described more fully hereinafter with reference to the accompanying drawings, in which some, but not all, embodiments are shown. Indeed, various embodiments may be embodied in many different forms and should not be construed as limited to the embodiments set forth herein; rather, these embodiments are provided so that this disclosure will satisfy applicable legal requirements.

The components illustrated in the figures represent components that may or may not be present in various embodiments of the invention described herein such that embodiments may include fewer or more components than those shown in the figures while not departing from the scope of the invention. Some components may be omitted from one or more figures or shown in dashed line for visibility of the underlying components.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in various embodiments,” “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The present disclosure provides various embodiments of a system and a method to determine a compensated SoS for a gas. Embodiments may be configured to determine a current temperature of a gas flowing within a gas channel. Embodiments may be configured to emit one or more signals within the gas to determine a gas flow rate. Embodiments may be further configured to determine a delta time of flight (dToF) of the one or more signals based at least on the determined gas flow rate. Further, embodiments may be configured to determine a gas flow rate based on the aToF and the dToF. Further, embodiments may be configured to determine a speed of sound (SoS) within the gas based at least on the aToF determined and a distance between at least two transducers of a second sensor. Further, embodiments may be configured to determine a compensated SoS for the gas based at least on the determined SoS, a base condition, the determined gas flow rate, and the determined current temperature of the gas. Embodiments may be configured to determine the temperature compensated SoS based on a linear transformation or on a non-linear model and the flow rate and temperature compensated SoS based on a linear or non-linear transformation model. Embodiments may be configured to determine an absolute time of flight (aToF) of one or more ultrasonic signals propagating through the gas between the at least two transducers in an upstream direction and a downstream direction. The mean absolute time of flight is calculated with the sum of upstream and downstream absolute time of flight divided by 2. The mean absolute time of flight is less flow rate dependent.

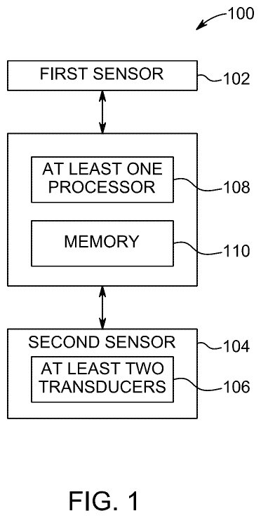

FIG. 1 illustrates a block diagram of a system 100 for determining a compensated speed of sound (SoS) for a gas, in accordance with an example embodiment of the present disclosure. The system 100 may comprise a first sensor 102, a second sensor 104 comprising at least two transducers 106, at least one processor 108 communicatively coupled to the first sensor 102 and the second sensor 104, and a memory 110.

In some embodiments, the first sensor 102 may be positioned within a gas channel. The first sensor 102 may comprise a temperature sensor. The first sensor 102 may be placed within the gas channel or in proximity to the gas channel. The first sensor 102 may be configured to determine a current temperature of a gas flowing within the gas channel. In one example, the current temperature may be determined in Celsius. The first sensor 102 may include at least one of thermocouples, resistance temperature detectors (RTDs), thermistors, or Infrared (IR) sensors. The first sensor 102 may be configured to respond to a change in the current temperature determined.

In some embodiments, the first sensor 102 may detect the change in the current temperature determined using a sensitive element. The sensitive element may comprise a thermocouple junction, a resistance temperature detector (RTD) wire, or a thermistor material. Further, the change in the current temperature may cause a change in physical property. The physical property may correspond to voltage, resistance, or IR radiation.

In some embodiments, the system 100 may comprise a second sensor 104. Further, the second sensor 104 may comprise at least two transducers 106. The second sensor 104 may be configured to determine a gas flow rate within the gas channel. Further, the at least two transducers 106 may be configured to emit one or more signals within the gas to determine the gas flow rate. The one or more signals may comprise one or more ultrasonic signals. The ultrasonic signals may comprise sound waves with frequencies higher than an upper audible limit of human hearing. The second sensor 104 may be placed within the gas channel or in the proximity of the gas channel. The second sensor 104 may comprise a flow rate sensor. Further, the flow rate sensor may comprise an ultrasonic sensor.

In some embodiments, the at least two transducers 106 may work in pairs. A first transducer may comprise a transmitter and a second transducer may comprise a receiver. Alternatively, both the first and second transducers may comprise transceivers. The at least two transducers 106 may be positioned on opposite sides of the gas channel. The one or more signals may travel from the first transducer to the second transducer. Further, the one or more signals may travel in an upstream direction and in a downstream direction relative to the gas flow. Further, time taken for the one or more signals to travel between the at least two transducers 106 may correspond to a time of flight.

Further, the system 100 may comprise the at least one processor 108. In some embodiments, the at least one processor 108 may correspond to a controller for executing one or more operations within a server. The at least one processor 108 may be communicatively coupled to the memory 110. In some embodiments, the at least one processor 108 may be configured to determine an absolute time of flight (aToF) of the one or more ultrasonic signals propagating through the gas between the at least two transducers in the upstream direction and the downstream direction. The aToF may correspond to the time the one or more signals may take to travel from the first transducer to the second transducer. In some embodiments, the first transducer may emit the one or more signals, and the second transducer may receive the emitted one or more signals. Further, the at least one processor 108 may collect time stamps when the one or more signals may be emitted and received. The at least one processor 108 may determine the aToF for the upstream direction and the downstream direction.

In some embodiments, the at least one processor 108 may be further configured to determine a delta time of flight (dToF) of the one or more signals based at least on the determined gas flow rate. The dToF may correspond to a difference between the aToF in the upstream direction and the aToF in the downstream direction. The aToF in the upstream direction may correspond to the time taken for the one or more signals to travel between the at least two transducers 106 against the direction of the gas flow. Further, the aToF in the downstream direction may correspond to the time taken for the one or more signals to travel between the at least two transducers 106 in the same direction of the gas flow.

In some embodiments, the at least one processor 108 may be configured to determine a gas flow rate based on the aToF and the dToF. In some embodiments, the at least one processor 108 may be further configured to determine a speed of sound (SoS) within the gas based at least on the aToF determined and a distance between the at least two transducers of the second sensor. The SoS may correspond to a speed at which the one or more signals may travel through the gas. The SoS may depend on the gas composition and temperature of the gas. In one example, the distance between the at least two transducers may correspond to 1 meter (m). The aToF in the upstream direction may correspond to 0.0025 seconds. The aToF in the downstream direction may correspond to 0.0023 seconds(s). Further, the dToF may corresponds to 0.0002 seconds. Further, the SoS may correspond to 416.67 m/s.

In some embodiments, the at least one processor 108 may be further configured to determine a compensated SoS for the gas based at least on the determined SoS, a base condition, the determined gas flow rate, and the determined current temperature of the gas. In some embodiments, the compensated SoS for the gas may be determined in a head end system (HES). The compensated SoS may correspond to a temperature compensated SoS or a flow rate compensated SoS. Further, the base condition may comprise a predefined temperature of the gas or a predefined flow rate and temperature of the gas. In one example, the predefined temperature may correspond to 20° C. In one example, the determined current temperature of the gas may correspond to 40° C., the SoS may be adjusted to reflect the SoS at 20° C.

In some embodiments, the at least one processor 108 may be configured to determine the temperature compensated SoS based on a linear transformation model and the flow rate and temperature compensated SoS based on a non-linear transformation model. The linear transformation model may be configured to adjust the SoS based at least on the current temperature of the gas. The linear transformation model may comprise at least two linear equations based at least on the determined SoS and the current temperature of the gas. The at least two linear equations of the linear transformation model may comprise an equation for determining compensated SoS of air and another equation for the compensated SoS of the gas.

The equation for determining compensated SoS of air is shown as:

$$SoS\_base [ m / s ] = SoS\_Raw [ m / s ] + 0.6 [ ( m / s ) / K ] * ( 293.15 [ K ] - t\_current [ K ] ) ,$$

in which SoS_base [m/s] may correspond to the compensated SoS. Further, SoS_Raw [m/s] may correspond to mean of the aToF. Further, 293.15 [K] may correspond to the temperature of 200° C. in Kelvins which may be changed. Further, t_current [K] may correspond to the current temperature.

The equation for determining compensated SoS of the gas methane is shown as:

$$SoS\_base [ m / s ] = SoS\_Raw [ m / s ] + 0.72 [ ( m / s ) / K ] * ( 293.15 [ K ] - t\_current [ K ] ) ,$$

Further, the non-linear transformation model may comprise one or more non-linear equations based at least on an absolute time of flight (aToF), the current temperature, and the determined gas flow rate. The non-linear transformation model, described further below, may be used to adjust the SoS based at least on the current gas flow rate and temperature.

In some embodiments, the at least one processor 108 may be further configured to determine the temperature compensated SoS based on a non-linear transformation model and the flow rate and temperature compensated SoS based on a linear transformation model.

The at least one processor 108 may include suitable logic, circuitry, and/or interfaces that are operable to execute one or more instructions stored in the memory 110 to perform predetermined operations. In some embodiments, the at least one processor 108 may be configured to store the current temperature of the gas, the aToF, the dToF, the SoS, the base condition, the linear transformation model, and the non-linear transformation model in the memory 110 communicatively coupled to the at least one processor 108. In one embodiment, the at least one processor 108 may be configured to decode and execute any instructions received from one or more other electronic devices or server(s). The at least one processor 108 may be configured to execute one or more computer-readable program instructions, such as program instructions to carry out any of the functions described in this description. Further, the processor may be implemented using the at least one processor 108 technologies known in the art. Examples of the at least one processor 108 include, but are not limited to, one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor).

In some embodiments, the memory 110 may be configured to store a set of instructions and data executed by the at least one processor 108. Further, the memory 110 may include the one or more instructions that are executable by the at least one processor 108 to perform specific operations. The memory 110 may be configured to store the determined current temperature. The memory 110 may be configured to include the instructions to determine the aToF of the one or more signals. The memory 110 may be configured to include the instructions to determine the SoS. Further, the memory 110 may be configured to include the instructions to determine the compensated SoS for the gas.

It is apparent to a person with ordinary skill in the art that the one or more instructions stored in the memory 110 enable the hardware of the system 100 to perform the predetermined operations. Some of the commonly known memory implementations include, but are not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

It will be apparent to one skilled in the art that above-mentioned components of the system 100 have been provided only for illustration purposes, without departing from the scope of the disclosure.

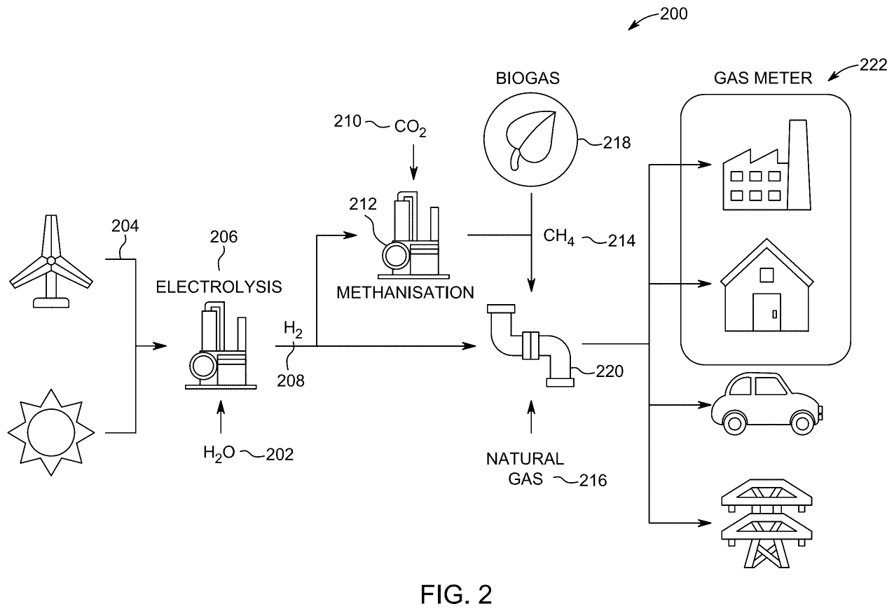

FIG. 2 illustrates flow of different gases within a distribution grid 200, in accordance with an example embodiment of the present disclosure.

In some embodiments, in the distribution grid 200, the gas composition may not be uniform to each different user. The user may correspond to an end user. The gas composition may not be uniform due to a plurality of sources of the gas. Further, the gas composition may not be uniform due to the gas being injected at one or more points. The gas may comprise, for example, hydrogen gas, methane gas, carbon dioxide gas, natural gas, and biogas. In some embodiments, the gas may undergo one or more processes before being injected into the distribution grid 200.

In some embodiments, water (H₂O) 202 along with a source of energy 204 may undergo electrolysis 206. The source of energy 204 may comprise, for example, solar energy and wind energy. The source of energy 204 may be configured to generate electricity. The electrolysis 206 may split the water (H₂O) 202 into the hydrogen gas 208 and the oxygen gas in the presence of the generated electricity. The process of electrolysis 206 may produce the hydrogen gas 208. In some embodiments, the hydrogen gas 208 may be produced via the electrolysis 206 using the source of energy 204. In some embodiments, the source of energy 204 may correspond to renewable energy sources. The renewable energy sources may include, but is not limited to, wind, solar, and hydro power.

In some embodiments, the hydrogen gas 208 may be combined with the carbon dioxide gas (CO₂) 210 in a process of methanisation 212 to produce synthetic methane 214. The carbon dioxide gas 210 may be captured from industrial process or directly from atmosphere and may be used in the methanisation 212 to create the synthetic methane 214. In some embodiments, the carbon dioxide gas 210 may be heavier than the synthetic methane 214 and the hydrogen gas 208. The carbon dioxide gas 210 may affect the speed of sound in the gas. The synthetic methane 214 may be used for residential, industrial, commercial, and transportation purposes. The synthetic methane 214 may be further used for heating, cooking, electricity generation, and power generation. Further, the synthetic methane 214 may have a high calorific value. In some embodiments, biogas 218 may be further used to produce the synthetic methane 214 naturally.

In some embodiments, the natural gas 216 may be a fossil fuel composed of the synthetic methane (CH₄) 214, with smaller amounts of hydrocarbons and trace amounts of nitrogen, carbon dioxide, sulfur compounds, and water vapor. The hydrocarbons may comprise, but are not limited to ethane, propane, and butane. The natural gas 216 may be found deep underground, often in association with oil fields, coal beds, and natural gas fields. The natural gas 216 may be extracted through drilling. The natural gas 216 may be used for residential, industrial, commercial, and transportation purposes. The natural gas 216 may be further used for heating, cooking, electricity generation, and power generation. The natural gas 216 may be used as a raw material for producing chemicals like fertilizers and hydrogen. Further, the natural gas 216 may be used as a cleaner alternative to gasoline and diesel. The natural gas 216 may produce fewer pollutants on burning. The natural gas 216 may have high energy content per unit.

In some embodiments, the hydrogen gas 208, the natural gas 216, and the synthetic methane 214 may go directly to a gas pipeline 220. Further, from the gas pipeline 220, the different gases may go to the user. The user may use different gases for different purposes. The different gases may be used in one or more in homes, cars, and industries, as shown by 222.

In some embodiments, the distribution grid 200 may have a plurality of injection points. Each of the plurality of injection points may introduce the different gases. The gas composition in the distribution grid 200 may be highly variable. The variation may be influenced by one or more factors. The one or more factors may comprise the type of gas being injected, the volume of the injection, time of the injection, and location of the injection. The different gases may have different quality.

In some embodiments, quality of the gas in the distribution grid 200 and calorific value of the gas may vary and may depend on the gas composition. The calorific value of the gas may correspond to the amount of energy released when the gas may be burned. In some embodiments, the different gases may have the different calorific value. In one example, the hydrogen gas may have a higher calorific value per unit mass than the methane gas. In some embodiments, the variation in the gas quality may affect combustion efficiency and emissions.

In some embodiments, due to high cost and complexity, installation of gas chromatographs at each of the plurality of injection points to measure the gas composition continuously may be impractical. The gas chromatographs may be used to analyze the chemical composition of gas samples. The gas chromatographs may provide information on type of the gas and concentrations of the different gases.

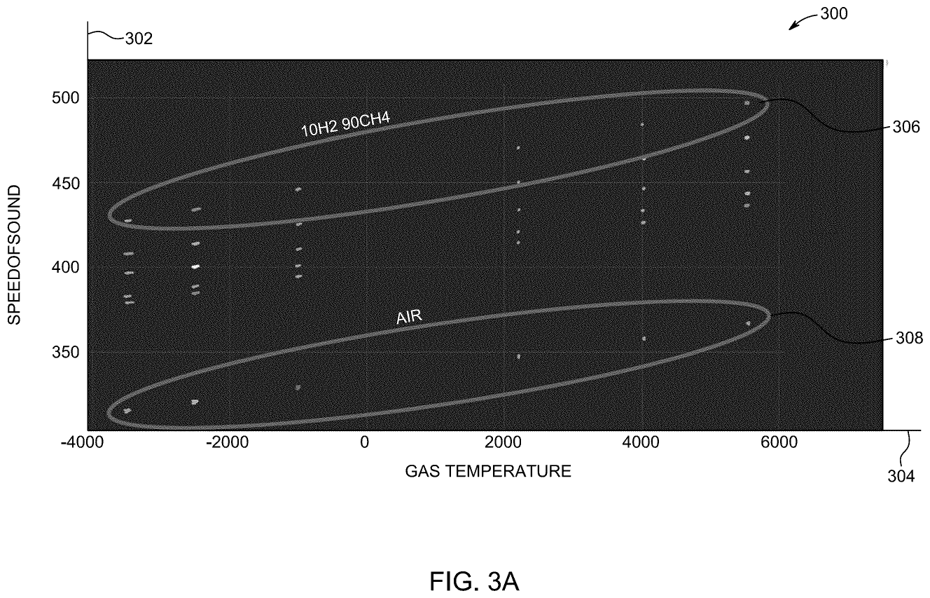

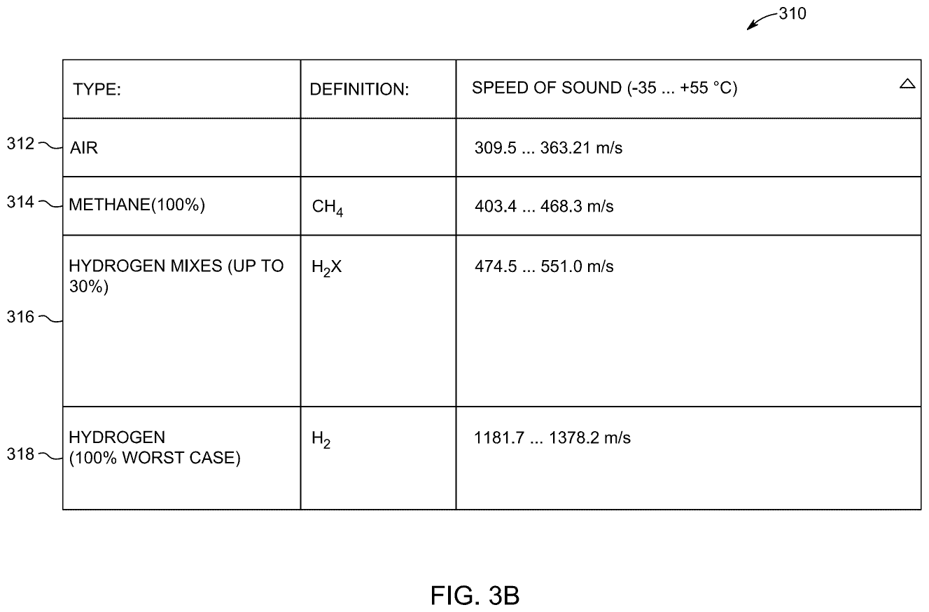

FIG. 3A illustrates a graph 300 showing a relation between the SoS and the current temperature of the gas, in accordance with an example embodiment of the present disclosure. FIG. 3B illustrates a table 310 showing the SoS related to the gas, in accordance with an example embodiment of the present disclosure.

In some embodiments, the SoS may be influenced by the gas composition and the temperature of the gas. The gas composition may refer to mixture of different gases within a given sample. In the distribution grid 200, the gas composition may vary due to the injection of different gases. The SoS in the gas may be inversely related to square root of molecular weight of the gas. The lighter gas may have the higher SoS, and the heavier gas may have the lower SoS. In one example, the hydrogen gas may have highest SoS as the hydrogen gas may have the lowest molecular weight, as shown in the table 310. In another example, the carbon dioxide gas may have a lower SoS when compared to the hydrogen gas.

In some embodiments, the injection of the different gases at the one or more injection points in the distribution grid 200 may create complex mixture of the different gases. Further, The SoS in the gas may be directly proportional to the square root of the temperature of the gas. The gas at the higher temperature may have the higher SoS. Higher temperature may correspond to higher thermal energy. As the thermal energy increases, average distance between the gas molecules may increase. As the average distance between the gas molecules increases, the SoS may increase. Further, the gas at the lower temperature may have the lower SoS. Lower temperature may correspond to the lower thermal energy. As the thermal energy decreases, the average distance between the gas molecules may decrease. As the average distance between the gas molecules decreases, the SoS may decrease.

In some embodiments, the graph 300 X axis showing the current temperature 304 of the gas and Y axis showing SoS 302. In some embodiments, the distribution grid 200 may contain 10% of the hydrogen gas and 90% of the methane gas (as shown in 306), and air (as shown in 308). The hydrogen gas may have highest speed of sound. In one example, the 10% of the hydrogen gas and 90% of the methane gas (as shown in 306) may have the speed of sound of about 430 meter per second (m/s) at lowest temperature. The lowest temperature may correspond to about-40° Celsius (C). In another example, the 10% of the hydrogen gas and the 90% of the methane gas (as shown in 306) may have the SoS of about 435 m/s at the temperature of about −25° C. In yet another example, the 10% of the hydrogen gas and the 90% of the methane gas (as shown in 306) may have the SoS of about 445 m/s at the temperature of about −10° C. In another example, the 10% of the hydrogen gas and the 90% of the methane gas (as shown in 306) may have the SoS of about 470 m/s at the temperature of approximately about 20° C. In yet another example, the 10% of the hydrogen gas and the 90% of the methane gas (as shown in 306) may have the SoS of about 480 m/s at the temperature of about 40° C. In yet another example, the 10% of the hydrogen gas and the 90% of the methane gas (as shown in 306) may have the SoS of about 500 m/s at the temperature of about 55° C.

In yet another example, the air (as shown in 308) may have the SoS of about 315 m/s at the temperature of about −35° C. In yet another example, the air (as shown in 308) may have the SoS of about 320 m/s at the temperature of about −25° C. In yet another example, the air (as shown in 308) may have the SoS of about 330 m/s at the temperature of about −10° C. In yet another example, the air (as shown in 308) may have the SoS of about 350 m/s at the temperature of approximately about 20° C. In yet another example, the air (as shown in 308) may have the SoS of about 360 m/s at the temperature of about 40° C. In some embodiments, there may be a linear correlation between the SoS in the gas and the temperature of the gas.

In some embodiments, the operational temperature range may vary significantly. The operational temperature in the distribution grid 200 may range from −35° C. to +55° C. The variation in the operational temperature in the distribution grid 200 may result in the variation in the SoS. To eliminate the impact of the variation in the operational temperature, the SoS may be converted to the base condition. The base condition may the predefined temperature of the gas or the predefined flow rate and temperature of the gas. Further, the predefined temperature may correspond to 20° C.

The SoS in the gas may be inversely related to the square root of the molecular weight of the gas. The lighter gas may have the higher SoS, and the heavier gas may have the lower SoS. In one example, range of the SoS of the air in the operational temperature may correspond to 309.5 m/s to 363.21 m/s (as shown in 312). The air may correspond to a mixture of the different gases. The air may have the higher molecular weight, and thus the lower SoS. In another example, the range of the SoS of the methane gas in the operational temperature may correspond to 403.4 m/s to 468.3 m/s (as shown in 314). The methane gas may comprise the hydrogen gas and the carbon molecules. The methane gas may have a comparatively lower molecular weight than the air, and thus the comparatively higher SoS.

In yet another example, the range of the SoS of hydrogen gas mixes (up to 30%) in the operational temperature may correspond to 474.5 m/s to 551.0 m/s (as shown in 316). The hydrogen mixes (up to 30%) may comprise the hydrogen gas and other molecules of the different gases. The hydrogen mixes (up to 30%) may have a comparatively lower molecular weight than the methane, and thus the comparatively higher SoS than the methane. In yet another example, the range of the SoS of the hydrogen gas in the operational temperature may correspond to 1181.7 m/s to 1378.2 m/s (as shown in 318). The hydrogen gas may comprise the hydrogen gas molecules. The hydrogen gas may have the lowest molecular weight, and thus having the highest SoS.

In some embodiments, the at least one processor 108 may be utilized to measure absolute time of flight (aToF) of ultrasonic waves propagating through the gas between the at least two transducers in upstream and downstream direction. The aToF may be dependent on the temperature and a gas composition density. The aToF may correspond to the measured time taken by the ultrasonic waves to travel between the at least two transducers. Further, the aToF may be utilized to calculate delta time of flight (dToF) of the ultrasonic waves propagating through the gas. The dToF may determine flow velocity of the gas.

Further, the first sensor 102 may be used to determine the gas temperature. The gas temperature may correspond to the current gas temperature. The second sensor 104 may correspond to the flow rate sensor. Further, the aToF and distance between the at least two transducers may be utilized to calculate the SoS in the gas. The at least two transducers may correspond to an ultrasonic transducer. The ultrasonic transducers may correspond to the device that may emit and receive the ultrasonic waves through the gas. The time taken for the ultrasonic waves to travel between at least two of the at least two transducers may be recorded. Further, a temperature compensated SoS or a flow rate and temperature compensated SoS for the gas may be generated at the base condition.

In some embodiments, the HES may correspond to a central control and monitoring unit within a gas distribution network. The HES may further correspond to the central control and monitoring unit where the gas supply may be collected, processed, and managed. In some embodiments, by continuously monitoring the SoS, the HES may detect variations in the gas composition as the different gases may be injected and mixed within the distribution grid 200. The different gas may correspond, but are not limited to, the natural gas, the LNG, the biogas, and the hydrogen gas. The HES may monitor the effects of injecting the different gases on the gas quality and the gas composition within the distribution grid 200. The different gases may correspond to renewable gas. Further, the at least one processor 108 may determine the compensated SoS for the gas in the HES.

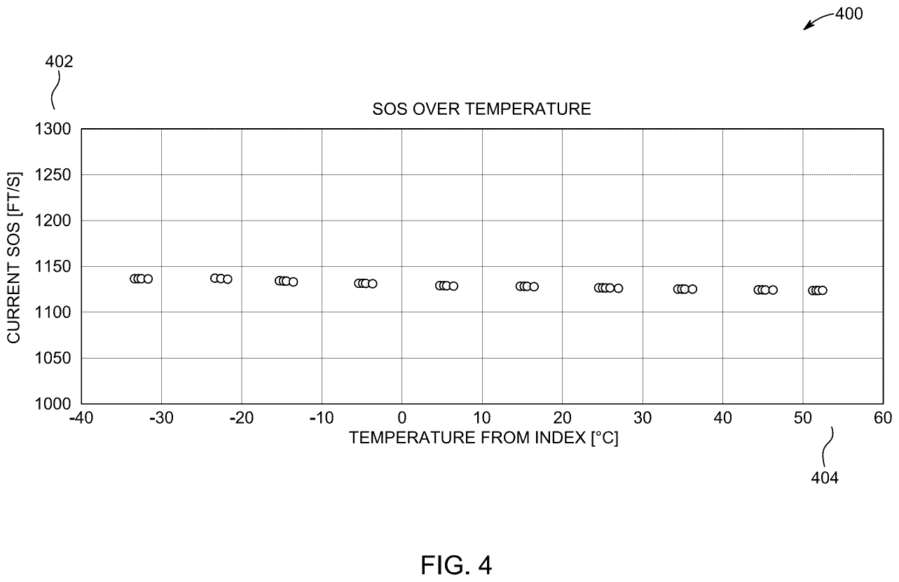

FIG. 4 illustrates a graph 400 showing a relation between the SoS and the current temperature of the gas in linear temperature conversion, in accordance with an example embodiment of the present disclosure.

In some embodiments, the graph 400 may correspond to the graph of the determined SoS 402 at the determined current temperature of the gas versus the determined current temperature of the gas 404. The graph 400 may be independent of the determined current temperature. In one example, there may be about 1145 feet per second (ft/s) SoS at the temperature around about −30° C. In another example, there may be about 1145 feet per second (ft/s) SoS at the temperature around about −20° C. In yet another example, there may be about 1135 feet per second (ft/s) SoS at the temperature around about −15° C. In yet another example, there may be about 1130 feet per second (ft/s) SoS at the temperature around about −5° C. In yet another example, there may be about 1130 feet per second (ft/s) SoS at the temperature around about 5° C. In yet another example, there may be about 1125 feet per second (ft/s) SoS at the temperature around about 15° C.

In yet another example, there may be about 1125 feet per second (ft/s) SoS at the temperature around about 25° C. In yet another example, there may be about 1125 feet per second (ft/s) SoS at the temperature around about 35° C. In yet another example, there may be about 1125 feet per second (ft/s) SoS at the temperature around about 45° C. In yet another example, there may be about 1125 feet per second (ft/s) SoS at the temperature around about 50° C. In some embodiments, after determining the compensated SoS for the gas based at least on the determined SoS, the base condition, the determined gas flow rate, and the determined current temperature of the gas, deviation over the overall temperature range may be less than 1%. And the deviation without determining the compensated SoS for the gas the calculated SoS at the determined gas temperature to the SoS at the predefined base temperature may be up to 15%.

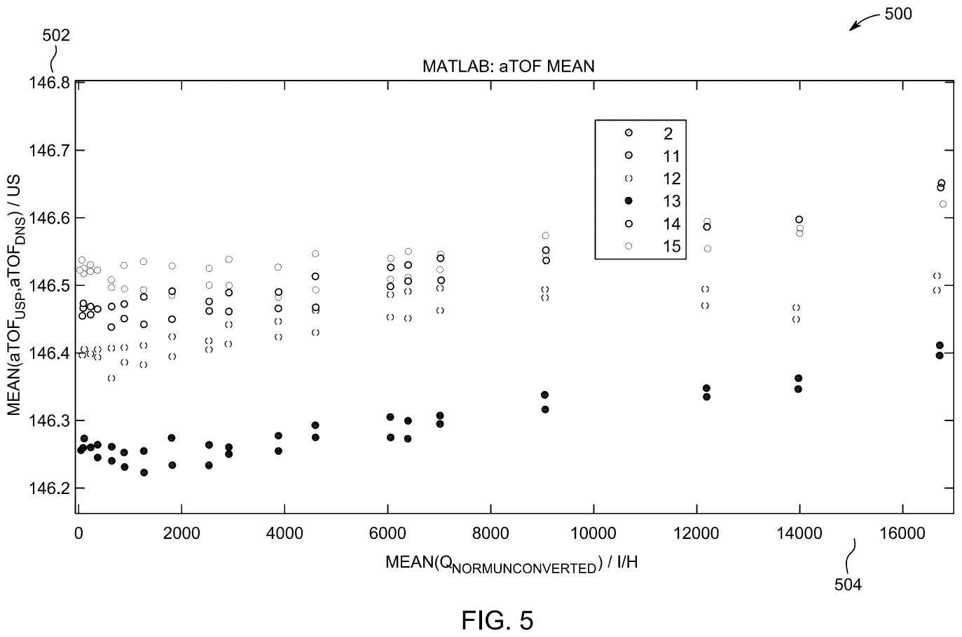

FIG. 5 illustrates a graph 500 showing a relation between mean of the aToF 502 and mean of the gas flow rate 504 in non-linear conversion, in accordance with an example embodiment of the present disclosure.

In some embodiments, the mean of the aToF 502 may exhibit a slight dependence on the gas flow rate. As the gas flow rate may increase, the mean aToF 502 value may also increase, potentially introducing a small error in the SoS determination. The flow rate and temperature compensated SoS may be based on the non-linear or linear transformation model. The non-linear transformation model may comprise a polynomial model. The non-linear transformation model may comprise one or more non-linear equations based at least on the aToF, the current temperature, and the determined gas flow rate. The at least on the aToF, the current temperature, and the determined gas flow rate may correspond to input of the non-transformation model. Using the input, the non-linear transformation model may output the compensated SoS. The non-linear transformation model may be trained using test data from real gas measurements taken at one or more temperatures and the gas flow rate. In some embodiments, the deviation in the SoS due to variations in the temperature, the gas flow rate, and the different gas composition may be reduced to less than 0.2%. The graph 500 may comprise different gases. Different meters may be represented by 2, 11, 12, 13, 14, 15. In one example, the gas (as shown in 2) may have a mean of the aToF 502 of about 146.53 when the gas flow rate 504 is between 0 to 2000 liter/hour. Further, the gas (as shown in 2) may have a mean of the aToF 502 of about 146.55 when the gas flow rate 504 is between 2000 to 4000 liter/hour. Then, the gas (as shown in 2) may have a mean of the aToF 502 of about 146.54 when the gas flow rate 504 is between 4000 to 6000 liter/hour. In some embodiments, the graph 500 may show there may be a non-linear relation between the mean of the aToF 502 and mean of the gas flow rate 504.

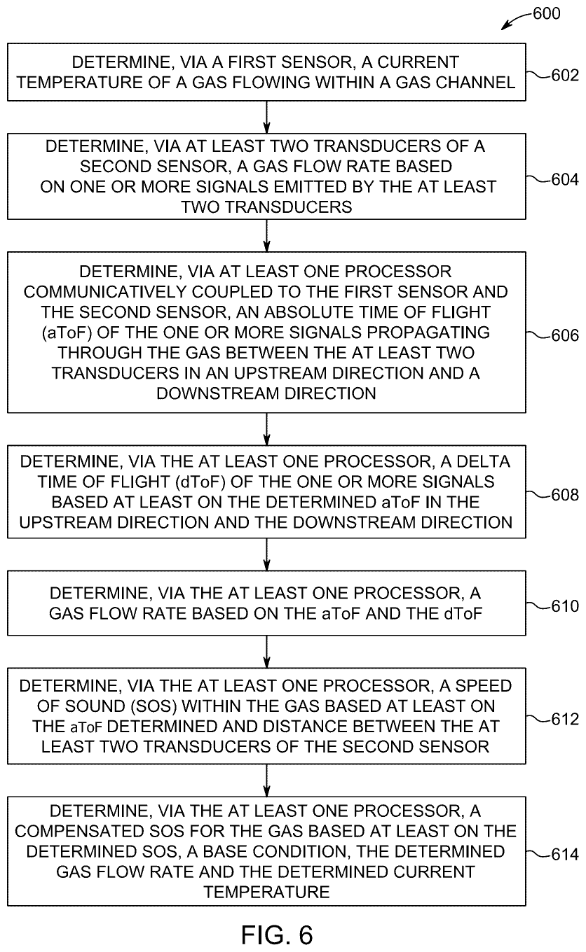

FIG. 6 illustrates a flowchart showing a method 600 to determine the compensated SoS for the gas, in accordance with an example embodiment of the present disclosure.

At operation 602, the first sensor 102 may be configured to determine the current temperature of the gas flowing within the gas channel. In some embodiments, the first sensor 102 may be positioned within the gas channel. The first sensor 102 may comprise a temperature sensor. The first sensor 102 may be placed within the gas channel or in proximity to the gas channel. The first sensor 102 may be configured to determine the current temperature of a gas flowing within the gas channel. In one example, the current temperature may be determined in Celsius. The first sensor 102 may include, but is not limited to thermocouples, resistance temperature detectors (RTDs), thermistors, or Infrared (IR) sensors. The first sensor 102 may be configured to respond to a change in the current temperature determined.

At operation 604, at least two transducers 106 of the second sensor 104 may be configured to determine the gas flow rate based on the one or more signals emitted by the at least two transducers 106 within the gas. The one or more signals may comprise the one or more ultrasonic signals. The one or more ultrasonic signals may comprise sound waves with frequencies higher than upper audible limit of human hearing. The second sensor 104 may be placed within the gas channel or in the proximity of the gas channel. The second sensor 104 may comprise a flow rate sensor. Further, the flow rate sensor may comprise an ultrasonic sensor.

In some embodiments, the at least two transducers 106 may comprise the first transducer and the second transducer. The first transducer may comprise the transmitter, and the second transducer may comprise the receiver. The at least two transducers 106 may be positioned on opposite sides of the gas channel. The one or more signals may travel from the first transducer to the second transducer. Further, the one or more signals may travel in an upstream direction and in a downstream direction relative to the gas flow.

At operation 606, the at least one processor 108 may be configured to determine an absolute time of flight (aToF) of the one or more signals propagating through the gas between the at least two transducers in an upstream direction and a downstream direction. The aToF in the upstream direction may correspond to the time taken for the one or more signals to travel between the at least two transducers 106 against the direction of the gas flow. Further, the aToF in the downstream direction may correspond to the time taken for the one or more signals to travel between the at least two transducers 106 in the same direction of the gas flow.

At operation 608, the at least one processor 108 may be configured to determine a delta time of flight (dToF) of the one or more signals based at least on the determined absolute time of flights (aToF) in the upstream direction and the downstream direction. The dToF may correspond to a difference between the aToF in the upstream direction and the aToF in the downstream direction. The dToF of the one or more signals may be determined to calculate the determined gas flow rate.

At operation 610, the at least one processor 108 may be configured to determine a gas flow rate based on the aToF and the dToF. Further, at operation 612, the at least one processor 108 may be configured to determine the speed of sound (SoS) within the gas, based at least on the aToF determined and the distance between the at least two transducers of the second sensor. In some embodiments, the SoS may correspond to the speed at which the one or more signals may travel through the gas. The SoS may depend on the gas composition and temperature of the gas. In one example, the distance between the at least two transducers may correspond to 2 m. The aToF in the upstream direction may correspond to 0.0025 seconds. The aToF in the downstream direction may correspond to 0.0023 seconds(s). Further, the dToF may correspond to 0.0002 seconds. Further, the SoS may correspond to 833.34 m/s.

At operation 614, the at least one processor 108 may be configured to determine the compensated SoS for the gas based at least on the determined SoS, a base condition, the determined gas flow rate, and the determined current temperature of the gas. In some embodiments, the compensated SoS for the gas may be determined in the HES. In some embodiments, the at least one processor 108 may be configured to determine the temperature compensated SoS based on the linear transformation model and the flow rate and temperature compensated SoS based on the non-linear transformation model. The linear transformation model may be configured to adjust the SoS based at least on the current temperature of the gas. The linear transformation model may comprise the equation for determining the compensated SoS of the air and another equation for the compensated SoS of the gas. Further, the non-linear transformation model may be used to adjust the SoS based at least on the current gas flow rate and current gas temperature. In some embodiments, the at least one processor 108 may be further configured to determine the temperature compensated SoS based on the non-linear transformation model and the flow rate and temperature compensated SoS based on the linear transformation model.

The present disclosure presents several advantages in measuring and compensating the SoS within the gas. The present disclosure may enable precise determination of the gas flow rate and quality, regardless of the current temperature of the gas. The present disclosure may ensure reliable and consistent data, crucial for effective billing and operational decision-making. The use of the first sensor, and the second sensor without the need for additional hardware, may be cost-effective and easy to implement. Furthermore, the capability to trace different gas compositions, as the different gases may propagate through the distribution grid may enhance the ability of gas suppliers to monitor and manage the impact of the different gas injections.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system comprising:
a first sensor configured to determine a current temperature of a gas flowing within a gas channel;
a second sensor comprising at least two transducers, wherein the at least two transducers, are positioned and configured to emit one or more signals within the gas to determine a gas flow rate; and
at least one processor communicatively coupled to the first sensor and the second sensor, wherein the at least one processor is configured to:
determine an absolute time of flight (aToF) of the one or more signals propagating through the gas between the at least two transducers in an upstream direction and a downstream direction;
determine a delta time of flight (dToF) of the one or more signals based at least on the determined aToF in the upstream direction and the downstream direction, wherein the dToF corresponds to a difference between the aToF in the upstream direction and the aToF in the downstream direction;
determine a gas flow rate based on the aToF and the dToF;
determine a speed of sound (SoS) within the gas based at least on the aToF determined and a distance between the at least two transducers of the second sensor; and
determine a compensated SoS for the gas based at least on the determined SoS, a base condition, the determined gas flow rate, and the determined current temperature of the gas.

2. The system of claim 1, wherein the compensated SoS corresponds to a temperature compensated SoS or a flow rate and temperature compensated SoS.

3. The system of claim 2, wherein the at least one processor is configured to determine the temperature compensated SoS based on a linear transformation model and the flow rate and temperature compensated SoS based on a non-linear transformation model.

4. The system of claim 3, wherein the linear transformation model comprises at least two linear equations based at least on the determined SoS and the current temperature of the gas, wherein the at least two linear equations of the linear transformation model comprise an equation for determining a compensated SoS of air and another equation for the compensated SoS of the gases.

5. The system of claim 4, wherein the non-linear transformation model comprises one or more non-linear equations based at least on an absolute time of flight (aToF), the current temperature, and the determined gas flow rate.

6. The system of claim 2, wherein the at least one processor is configured to determine the temperature compensated SoS based on a non-linear transformation model and the flow rate and temperature compensated SoS based on a linear transformation model.

7. The system of claim 1, wherein the first sensor is positioned within the gas channel and comprises a temperature sensor and the second sensor is positioned within the gas channel and comprises a flow rate sensor.

8. The system of claim 7, wherein the flow rate sensor comprises an ultrasonic sensor and the one or more signals comprise one or more ultrasonic signals.

9. The system of claim 1, wherein the base condition comprises a predefined temperature of the gas or a predefined flow rate and temperature of the gas.

10. The system of claim 1, wherein the compensated SoS for the gas based at least on the determined SoS, a base condition, the determined gas flow rate, and the determined current temperature of the gas is determined in a head end system.

11. A method comprising:
determining, via a first sensor, a current temperature of a gas flowing within a gas channel;
determining, via a second sensor comprising at least two transducers, a gas flow rate based on one or more signals emitted by the at least two transducers within the gas;
determining, via at least one processor communicatively coupled to the first sensor and the second sensor, an absolute time of flight (aToF) of the one or more signals propagating through the gas between the at least two transducers in an upstream direction and a downstream direction;
determining, via the at least one processor, a delta time of flight (dToF) of the one or more signals based at least on the determined aToF in the upstream direction and the downstream direction, wherein the dToF corresponds to a difference between the aToF in the upstream direction and the aToF in the downstream direction;
determining, via the at least one processor, a gas flow rate based on the aToF and the dToF;
determining, via the at least one processor, a speed of sound (SoS) within the gas, based at least on the aToF determined and a distance between the at least two transducers of the second sensor; and
determining, via the at least one processor, a compensated SoS for the gas based at least on the determined SoS, a base condition, the determined gas flow rate, and the determined current temperature of the gas.

12. The method of claim 11, wherein the compensated SoS corresponds to a temperature compensated SoS or a flow rate and temperature compensated SoS.

13. The method of claim 12, wherein the at least one processor is configured to determine the temperature compensated SoS based on a linear transformation model and the flow rate and temperature compensated SoS based on a non-linear transformation model.

14. The method of claim 13, wherein the linear transformation model comprises at least two linear equations based at least on the determined SoS and the current temperature of the gas, wherein the at least two linear equations of the linear transformation model comprise an equation for determining a compensated SoS of air and another equation for the compensated SoS of the gases.

15. The method of claim 14, wherein the non-linear transformation model comprises one or more non-linear equations based at least on an absolute time of flight (aToF), the current temperature, and the determined gas flow rate.

16. The method of claim 12, wherein the at least one processor is configured to determine the temperature compensated SoS based on a non-linear transformation model and the flow rate and temperature compensated SoS based on a linear transformation model.

17. The method of claim 11, wherein the first sensor is positioned within the gas channel and comprises temperature sensor and the second sensor is positioned within the gas channel and comprises a flow rate sensor.

18. The method of claim 17, wherein the flow rate sensor comprises an ultrasonic sensor and the one or more signals comprise one or more ultrasonic signals.

19. The method of claim 11, wherein the base condition comprises a predefined temperature of the gas or a predefined flow rate and temperature of the gas.

20. The method of claim 11, wherein the compensated SoS for the gas comprises at least on the determined SoS, a base condition, the determined gas flow rate, and the determined current temperature of the gas is determined in a head end system.
